(19) United States
(12) Patent Application Publication
(10) Pub. No.: US 2011/0126413 A1
(43) Pub. Date: Jun. 2, 2011

(54) RAZOR CARTRIDGE COMPONENTS WITH INDICIA

(76) Inventors: Andrew Anthony Szczepanowski, North Attleboro, MA (US); Jennifer Ruth Kinard, Cambridge, MA (US); Robert Harold Johnson, Melrose, MA (US)

(21) Appl. No.: 12/629,249

(22) Filed: Dec. 2, 2009

(51) Int. Cl. B26B 21/40; B26B 21/14; B21K 21/00; B26B 21/54

(52) U.S. Cl. 30/41; 30/77; 30/84; 76/101.1; 30/346.52

(57) ABSTRACT

A novel razor cartridge is disclosed where the cartridge comprises at least one indicium incorporated onto an exterior surface of at least one component of the razor cartridge.

The indicia may include functional and/or aesthetic benefits communicated or obtained to the user before, during or after use the razor product. In one embodiment, the indicia are water droplets recessed into the lube ring of the razor cartridge, conveying the benefits of the lube ring and/or razor product to the consumer such as skin moisturization and/or the release of lubricant.

### FIELD OF THE INVENTION

This invention relates to razors, and more particularly to improvements in razor cartridge components.

### BACKGROUND OF THE INVENTION

In many instances, when a consumer purchases a razor system or disposable package, there is typically, an outer razor package having information about the razor product inside, which is opened. Once opened, the outer package is oftentimes thrown away since a consumer might naturally hold onto only the razor and any dispenser package or extra razor cartridges but not the outer packaging. Consequently, any information provided about the features of the particular razor product on the outer package will subsequently not be available to the consumer; detailed information about the razor characteristics are typically not found on the razor product itself, nor on the dispenser packages or extra razor cartridges.

With more and more features being included in razor systems and razor cartridges, it may be desirable to provide more information about razor components to the user not only right before use but when choosing, using and/or after use.

Thus, there is a need to provide a unique razor product and method of manufacturing a razor suitable for both male and female razors enabling any consumer to be beneficially pleased and informed when choosing and using the razor products.

### SUMMARY OF THE INVENTION

In accordance with the present invention, a novel razor includes at least one indicium incorporated onto at least one exterior surface of at least one razor cartridge component which includes a portion of at least one of the following: a lubricating body, a cap, a housing, a frame, a clip, a guard, a razor blade, a cartridge connecting structure, or any combination thereof.

The at least one indicium includes one or more pattern, graphic, text, design, fragrance, or any combination thereof. The at least one indicium includes one or more water droplets, flowers, floral patterns, bubbles, sparkles, words, images, scents, or any combination thereof.

The at least one indicium provides a user with at least one functional benefit, at least one aesthetic benefit, or any combination thereof. The at least one functional benefit includes increased lubricant release, release of a scent during use, skin or hair improvements further comprising moisturization, hair minimization or acne-reduction, or any combination thereof.

The at least one aesthetic benefit includes at least one pleasing sensation, at least one pleasing emotion obtained via a scent released during use, improved skin appearance, or a feeling that said razor cartridge is appealing, refreshing, clean, easy to use, moisturizing, relaxing, soothing, or safe for sensitive skin, or any combination thereof.

Each of the benefits of the indicia is obtained by a user before, during or after use of the razor cartridge or any combination thereof.

The at least one indicium incorporated into at least one component of a razor cartridge is visible to a user at a point of purchase of a razor product.

The present includes a method of making a razor cartridge including incorporating at least one indicium on at least one exterior surface of at least one component of the razor cartridge wherein the at least one razor cartridge component includes a portion of at least one of the following: a lubricating body, a guard, a cap, a housing, a frame, a clip, a razor blade, a cartridge connecting structure, or any combination thereof.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

Other features and advantages of the invention will be apparent from the following detailed description, and from the claims.

### BRIEF DESCRIPTION OF THE DRAWINGS

While the specification concludes with claims particularly pointing out and distinctly claiming the subject matter which is regarded as forming the present invention, it is believed that the invention will be better understood from the following description which is taken in conjunction with the accompanying drawings in which like designations are used to designate substantially identical elements, and in which:

FIG. 1 is a perspective view of a razor cartridge showing indicia incorporated onto an exterior surface of a lubricating body (e.g., lube ring) in accordance with the present invention.

FIG. 1A is a front view of a razor cartridge of FIG. 1 attached to a razor handle.

FIG. 2 depicts the pattern incorporated onto the lubricating body of FIG. 1 showing indicia incorporated therein.

FIG. 3 is a perspective view of the lubricating body of FIG. 1 showing indicia incorporated therein.

FIG. 3A is a diagram showing the dimensions of the types of indicia of FIGS. 1-3.

FIG. 3B is a diagram showing the dimensions in the lube ring of FIGS. 1-3.

FIG. 4 is a diagram showing a consumer detecting the indicia of a lubricating body of a razor product in a package from a store shelf in accordance with the present invention.

FIG. 5A depicts a front view of a razor cartridge showing a lubricating body (e.g., lube ring) having a floral or vine-like pattern of indicia in accordance with the present invention.

FIG. 5B depicts a front view of a razor cartridge showing a lubricating body (e.g., lube ring) having a bubble pattern of indicia in accordance with the present invention.

FIG. 5C depicts a front view of a razor cartridge showing a lubricating body (e.g., lube ring) having an alternate bubble pattern of indicia in accordance with the present invention.

FIG. 5D depicts a front view of a razor cartridge showing a lubricating body (e.g., lube ring) having a flower pattern of indicia in accordance with the present invention.

FIG. 5E depicts a front view of a razor cartridge showing a lubricating body (e.g., lube ring) having text indicia forming a word in accordance with the present invention.

FIG. 5F depicts a front view of a razor cartridge showing a lubricating body (e.g., lube ring) having alternate text indicia in accordance with the present invention.

FIG. 5G depicts a front view of a razor cartridge showing a lubricating body having graphic indicia in accordance with the present invention.

FIG. 5H depicts a front view of a razor cartridge showing a lubricating body having a combination of types of indicia in accordance with the present invention.

FIG. 5I is a side view of FIG. 5H.

FIG. 5J depicts a front view of a razor cartridge showing a lubricating body having two layers each with indicia in accordance with the present invention.

FIG. 5K is a side view of FIG. 5J.

FIG. 6 is a perspective view of a razor cartridge showing indicia incorporated onto an exterior surface of a lubricating strip in accordance with the present invention.

FIG. 7 is a perspective view of a razor cartridge showing indicia incorporated onto exterior surfaces of lubricating bodies (e.g., lube ring and lubricating strip) in accordance with the present invention.

FIG. 8 is a top view of a razor cartridge showing indicia incorporated onto an exterior surface of a lubricating body (e.g., soap wings or gel bars) in accordance with the present invention.

FIG. 9 is a top view of a razor cartridge showing indicia incorporated onto an exterior surface of a lubricating body (e.g., foam) in accordance with the present invention.

FIG. 10 is a front view of a razor cartridge showing indicia incorporated onto exterior surfaces of lubricating body (e.g., lubricating strip or shaving aid material) disposed on clips of the razor cartridge.

FIG. 11 is a front view of a razor cartridge showing indicia incorporated onto an exterior surface of a frame of the razor cartridge in accordance with the present invention.

FIG. 12 is a front view of a razor cartridge showing indicia incorporated onto exterior surfaces of several razor components in accordance with the present invention.

### DETAILED DESCRIPTION OF THE INVENTION

In a major aspect, the invention relates to a novel razor product having a razor cartridge which includes at least one indicium or indicia incorporated onto an exterior surface of a lubricating body of the razor cartridge where the indicia provide at least one functional benefit, at least one aesthetic benefit or any combination thereof, to the user.

Indicia are not generally provided on commercially available razor product components such as lubricating bodies and users generally may not be aware of component benefits just by looking at the product itself. For instance, a user may not be aware that a portion of a razor cartridge such as a lubricating body was providing a lubricious benefit since oftentimes, the lubricating ring or lubricating strip may be mistaken by users as being nothing more than a plastic portion of the housing (e.g., the Gillette® Venus® Embrace™).

Lubricating Body

A “lubricating body” in the present invention is a razor cartridge component and may include, but is not limited to, a solid shaving aid material in the form of a lubricating strip (oftentimes referred to as a “lubrastrip”), a soap or gel (e.g., wings with gel bars or soap wings), a lubrication ring (oftentimes referred to as a “lube ring”), a foam embedded with a shaving aid material or any other lubricious composition or formulation, or any combination thereof.

Any desired formulation may be used for the shaving aid material. Desirably, the shaving aid material has sufficient wear resistance so that the lubricating body lasts for about the intended life of the cartridge. However, the shaving aid material may also be exhausted before it is necessary to replace the cartridge.

In the present invention, as will be described in more detail below, indicia incorporated on a lubricating body or other razor cartridge component may include an added fragrance by placement of one or more drops of fragrance or scented oil, beads or creme.

In some instances (e.g., with gel bars or soap wings), the shaving aid material used may include soap (e.g., poured or extruded soap). Such soap-based compositions may be modified to increase their hardness, wear resistance, lubricity and/or skin moisturizing and conditioning properties. For lubricating strips (lubrastrips), which are generally extruded, the shaving aid material desirably comprises a polymeric material, generally a lubricious water-soluble polymer, such as polyethylene oxide, which leaches out of the strip during shaving to enhance shave comfort and optionally a water-insoluble polymer, typically polystyrene. Adding a polycaprolactone material may improve the fabrication of the shaving aid strip, provide smoother strip surfaces and permit the inclusion of greater amounts of water-soluble polymer in the strip to cause a release of more shaving aid during use. For lubrication rings (lube rings) which are generally molded, the shaving aid material generally comprises a similar composition of polymeric material as described above for lubricating strips.

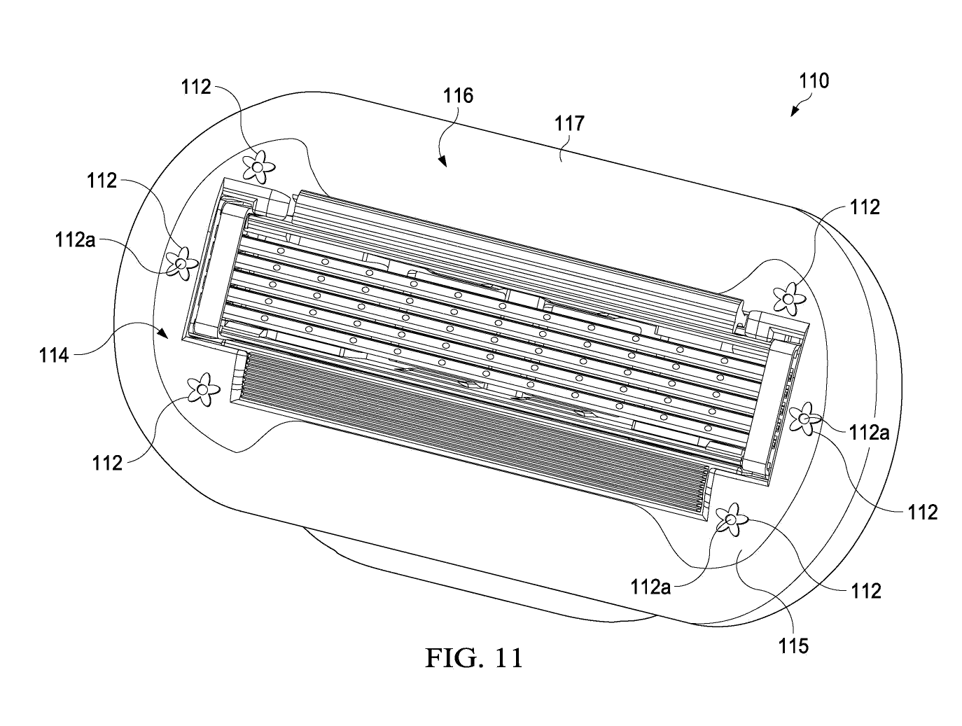

The lubricating body of the present invention may also further include lubricating bodies on any other razor cartridge component or portion thereof where shaving aid material or any lubricant material or other formulation is coated or disposed on an exterior surface of the razor component. Razor cartridge components such as the guard, the cap, the housing, the frame, the clip, the razor blade, the cartridge connecting structure, or any combination thereof are contemplated in the present invention and described below. The guard is typically disposed in the area in front of the blades, oftentimes including one or more flexible elastomeric elements, while the cap area is generally the area behind the blades, oftentimes made of a smooth elastomeric material and/or inclusive of a lubrastrip. The frame may generally indicate a plastic area of the cartridge that the lube ring may be disposed onto and may surround the blades, while the housing may generally signify the plastic structure securing the blades prior to their placement in the frame. The clips are generally metallic pieces typically placed on the ends of the razor blades for securing the blades together in the housing. The cartridge connecting structure is the intermediate structure connecting the razor cartridge with a razor handle. Several examples of indicia on razor cartridge components are described below. For instance, FIG. 11 depicts clips having shaving aid material disposed thereon.

Indicia

In the present invention, an “indicium,” or “indicia” in its plural form, may signify one or more discriminating marks, signs, tokens, indications, or appearances on a lubricating body and/or a razor cartridge component with or without a lubricating body thereon. The indicium or the indicia of the present invention provide and/or convey one or more “functional” benefits and/or one or more “aesthetic” benefit(s) to a consumer, as defined below. In many instances, the one or more indicia may correspond to characteristics or benefits of the razor cartridge components and thus may assist in communicating these characteristics or benefits to a consumer or user. Several examples of types of indicia incorporated onto a portion of the exterior surface of a razor cartridge component, such as, but not limited to, a lubricating body of a razor cartridge are described below in accordance with the present invention.

Types of Indicia

Generally an indicium or the indicia of the present invention may include, but are not limited to, one or more graphic, pattern, design, text, fragrance, or any combination thereof. Graphics may include pictures (e.g., a man's or woman's face), logos, images, shapes, or charts or any combination thereof. An indicium may generally be anything, such as for example, a water droplet, a flower, a bubble, or a sparkle. A group of water droplets or other indicia may form a pattern or design. A pattern may include one or more decorative or ornamental markings (e.g., water droplets, flowers, bubbles, sparkles, etc.) where such markings may be repeated or combined with other patterns. Designs may include sketches or artworks of flowers, vines, lace, or any other desirable schemes or combinations thereof. Text may include any writings with letters, numbers, or symbols or any combination thereof. The indicia of the present invention are not intended to cover known prior art color-changes on lubricating strips or other lubricating bodies. The indicia of the present invention may be geared to a particular demographic, age group, (e.g., young men or teenage or pre-teen girls) or country and could also include, for instance, a hologram for showing a three dimensional image or the indicia of the present invention may include a fragrance or scent.

Indicia Benefits

A “functional benefit” of the indicia of the present invention pertains to having an advantage communicated to or obtained by a user (or prospective user or consumer) before, during or after the operation or use of the razor product (e.g., while shaving) involving, or concerned with the functionality or usage of the product. This functional benefit may be communicated to a user at the point of purchase (e.g., before use or when choosing a product). For instance, a user may determine that a product has a functional benefit based on the indicia on the razor product in a razor package displayed on a store shelf. The functional benefit may be obtained by the user during use as well. For instance, the functional benefit desirably may include a faster leaching time or an increased release of lubricant or having a scent released from indicia disposed on an exterior surface of a lubricating body or other component of a razor cartridge.

“Leaching” as used herein may be generally defined as the release of lubricant or soluble constituents from a lubricating body. A razor cartridge component may have a lubricating body disposed thereon in the present invention. For instance, in the case of porous lubricating rings or strips made from a matrix of polyethylene oxide (oftentimes referred to as “polyox”) and polystyrene, the leaching of a lubricating ring or strip may signify the dissolving out or the release of constituents such as the polyox. In the case of an impregnated foam or sponge type of lubricating body, the leaching or release of lubricant generally occurs from the pores of the impregnated foam or sponge. In the case of lubricating bodies such as gel bars, whether or not polyox is part of the formulation of the gel bars, a release of lubricant or soap is still realized (e.g., a wearing away). As will be discussed below, the leaching rate of the present invention may theoretically be estimated as being in the range from about 5% to about 40% over prior art lube rings and desirably about 10% to about 30% weight loss from an original amount after up to about a four to six minute soak period.

The formulation of the lubricant in the indicia may also include ingredients that operationally may provide hair improvements such as but not limited to, hair minimization or hair reduction. Additionally, the indicia may serve to provide a user with the functional benefit of providing skin moisturization, acne-reduction or any other skin improvements during and/or after use.

An “aesthetic benefit” of the indicia of the present invention pertains to an advantage communicated to or obtained by a user (or prospective user) before, during, or after, operation or use of the razor product involving, or concerned with pure emotion and sensation as opposed to pure intellectuality and may include one or more aspects of beauty. In many instances, this aesthetic benefit may be a pleasing sensation or emotion provided to a user (e.g., a feeling or opinion that a product is appealing or attractive, that it may be easy or fun to use, that it may be safe for sensitive skin, etc.) by the product at the point of purchase (e.g., before use). However, an aesthetic benefit may be obtained by the user during use as well. For instance, the aesthetic benefit of a pleasing scent or other sensation may be realized as the user is operating the razor. Additionally, the indicia may serve to provide a user with the aesthetic benefit of skin that looks good or appears moist or otherwise improved after such use.

The aesthetic or functional benefits described herein may be achieved in the present invention without requiring a new routine, a new way of thinking, or extra work for the consumer. Furthermore, the indicia may also beneficially minimize any confusion or guesswork about a razor's attributes or may inspire the user to be more attentive to the characteristics of the razor and how the razor feels against their skin during use.

Incorporating Indicia

Depending on the desire and/or type of indicia, any suitable process or means of incorporating, attaching, or coupling the indicia onto at least a portion of an exterior surface of a razor cartridge component such as a lubricating body of a razor cartridge is contemplated in the instant invention. For instance, the indicia of the present invention may be wholly or partially recessed in, protruding from, printed on (e.g., inkjet printing, laser printing, thermal printing, among other printing methods), painted or brushed onto, sealed onto, stenciled onto, etched into, encapsulated into, or any combination thereof, the at least one exterior surface of the lubricating body or other razor cartridge components. In addition, the indicia may include a fragrance.

The present invention also contemplates the exterior surface of a lubricating body or other razor cartridge component having indicia incorporated within or on other indicia as will be described in the embodiments below. For instance, some examples of indicia within other indicia may include a recessed portion having a printed portion disposed thereon, a recessed portion having an encapsulated or other indicia disposed therein, or a first indicia formed in an upper layer of an exterior surface of a lube ring material while a second indicia is formed in a lower layer of an exterior surface of a lube ring material, such that as the upper area of indicia of the lube ring wears away with use, a new area of indicia in the lower layer will become visible or apparent in a portion of the exterior surface.

To incorporate recessed and protruding indicia on a razor cartridge component such as lubricating body (e.g., a lube ring), one desirably may utilize injection molding presses to form the indicia in the desirable fashion (e.g., different molds for different features and for achieving a recessed portion or a protruding portion or any combination thereof). The molding of a lube ring may place the features of the indicia on the lube ring while simultaneously positioning the lube ring onto the cartridge, completing the formation of the cartridge. Any conceivable area of the indicia of the present invention may be recessed or protruding. For instance, each indicia may protrude in its entirety from the exterior surface of a lubricating body or may protrude only in a perimeter area or another portion of each indicia may protrude, or any combination thereof. Similarly, each indicium may be recessed in its entirety from the exterior surface or only recessed in a perimeter area or any other portion of each indicia may be recessed or any combination thereof. Additionally, the recesses into or protrusions from the exterior surface of a component or lubricating body may be formed at slight angles on the sides of about 2 to 10 degrees or as desired to enable adequate extraction from the mold.

The printing of indicia onto an exterior surface of a lubricating body may desirably be achieved via, but is not limited to, inkjet, laser or thermal printing through the use of any commercially available equipment. Painting indicia onto an exterior surface of a lubricating body may be achieved by traditional painting, brushing or spraying techniques or any other known useful technique. The sealing of indicia onto an exterior surface of a lubricating body such as a lube ring, of a razor cartridge may be achieved by any type of adhesive, tape or shrink wrap or any other known useful technique.

Stenciling of indicia may be desirably achieved using steel stencil or template or using a lithographically etched mask made of steel or glass. The steel mask or stencil may have apertures respectively placed over the selected areas of the cartridge where indicia are to be placed. The apertures may provide any type of indicia, e.g., Venus®, a trade name, or flowers or other designs.

The etching of indicia onto an exterior surface of a lubricating body may desirably be achieved via ion or chemical etching or any other feasible etching technique such as RF etching, plasma, light-based etching or any combination thereof.

In order to form “indicia within indicia” in the present invention, a desirable technique may also include several steps of injection molding, where a first indicium/ia may be molded (e.g., a recessed water droplet) and a second indicia may be molded thereon (e.g. a protruding letter within the recessed water droplet). Alternatively, a first indicium/ia may be molded (e.g., a recessed flower) and a second indicia (e.g., a formulation area) may be deposited in the center of a top portion of the first indicia.

With regard to the inclusion of indicia that may not be apparent, a formulation may be encapsulated or otherwise disposed onto an exterior surface of a lubricating body by adding thereon a formulation layer or formulation areas (wherein the formulation may have a scent) as a last step in the forming of the lubricating body. The formulation areas may be disposed as one or more drops of essential oil or scented beads or other ingredients, which may, for instance, once placed in contact with water, emanate or release a scent or fragrance which in turn is conveyed to the user.

With regard to the layering of indicia such that as one area with indicia on the exterior surface of the lubricating body wears away, another area of indicia (that may or may not have been apparent from the original exterior surface) will then surface to the exterior, a desirable technique may include, as mentioned above, several steps of injection molding pressing to incorporate indicia. For instance, an upper or outer layer of the present invention may include recessed portions while a lower layer (surfacing to the exterior surface after upper layer has worn away) of the present invention may include any other type of indicia (e.g., text designation indicating that the lubrication may be exhausted).

For the formation of indicia such as sparkles for example, which are generally made of metallic, glass or plastic reflective chips, or any combination thereof, on the microscopic scale, a desirable technique of incorporating such sparkles onto the exterior surface of a lubricating body may be to blend the sparkle material with the raw material of the lube ring during injection molding. Or alternatively, sparkles may be achieved by painting or printing sparkles on an outer layer of the exterior surface of the razor cartridge component such as a lubricating body.

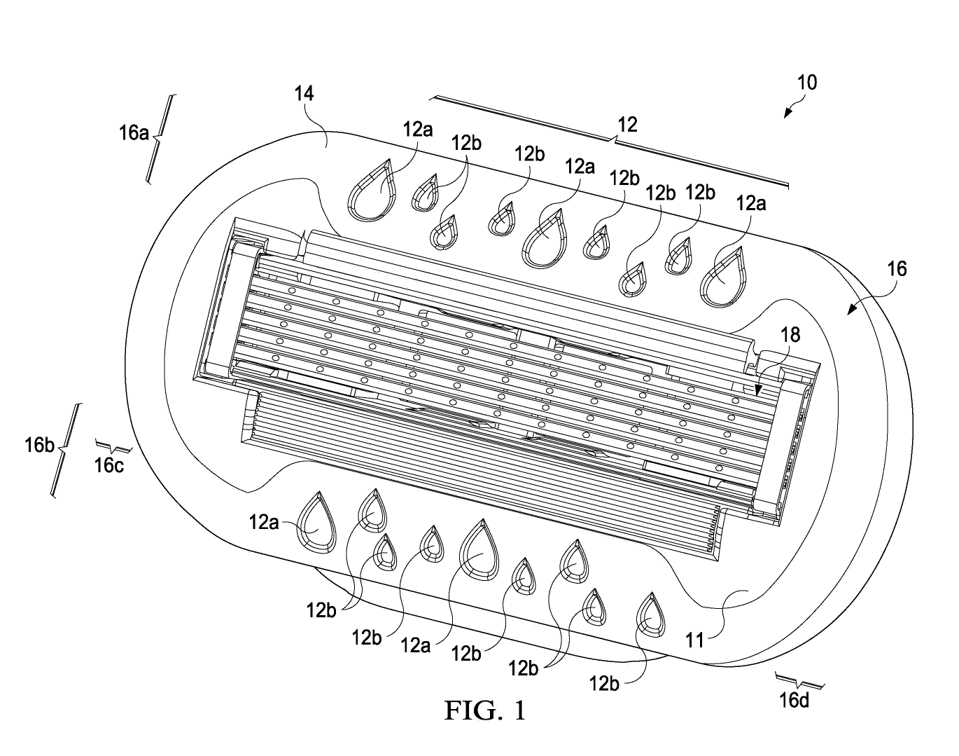

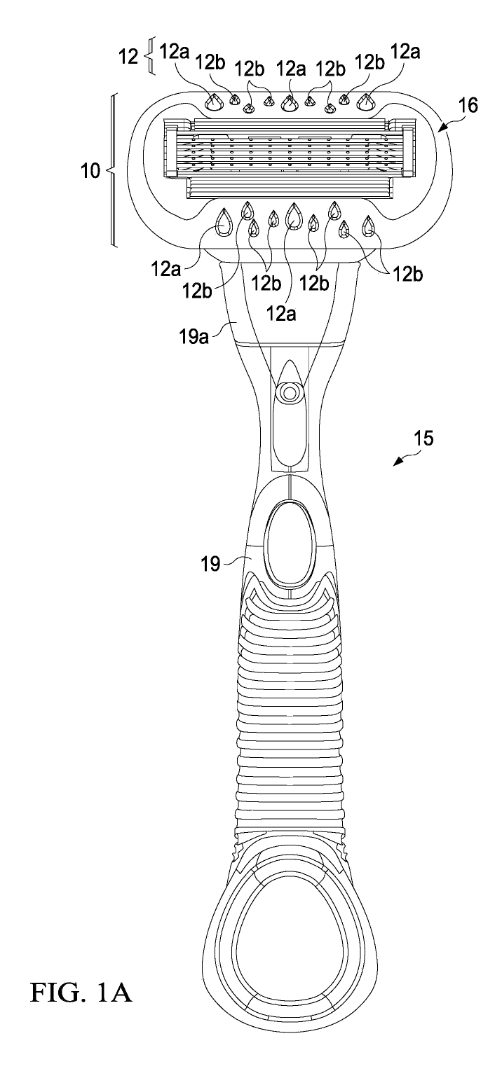

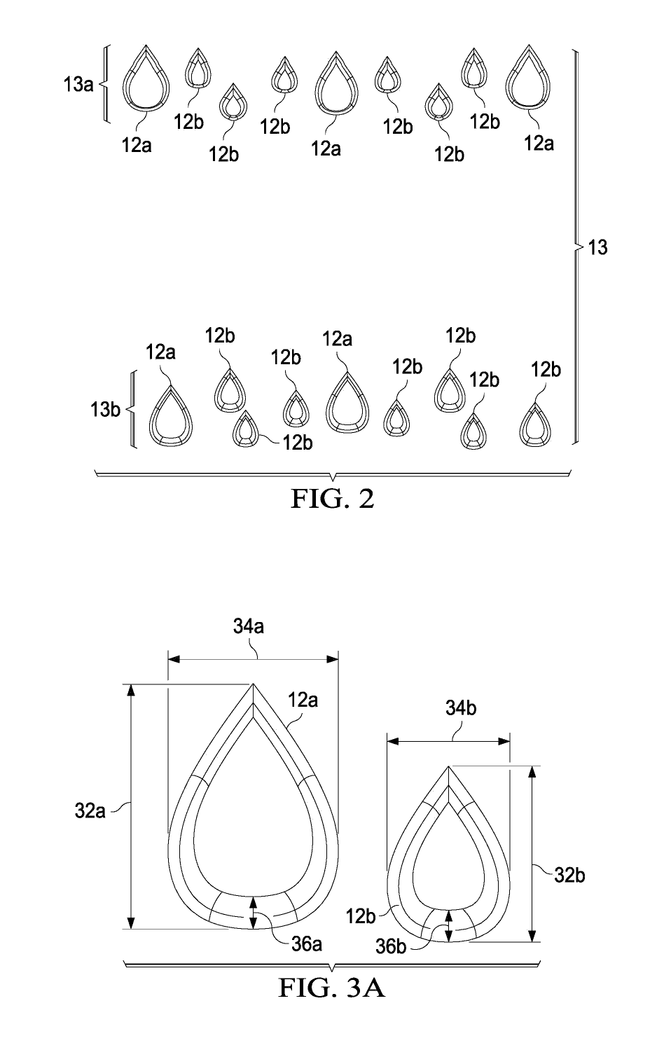

Referring now to FIG. 1 of the present invention, razor cartridge 10 is shown to include indicia 12 incorporated onto an exterior surface 14 of a lubricating body, shown here as a lube ring 16, where indicia 12 form a pattern 13 (shown separately in FIG. 2) of large water droplets 12a and small water droplets 12b. The indicia 12 comprising water droplets 12a and 12b on lube ring 16 communicate or convey both functional and aesthetic benefits to/for the user as will be described below.

While pattern 13 formed of water droplets 12a and 12b may be in any arrangement feasibly desired, the pattern 13 shown in FIG. 1 includes three large water droplets 12a and six small water droplets 12b incorporated on an upper portion 16a of lube ring 16 and includes three large water droplets 12a and six small water droplets 12b incorporated on a lower portion 16b of lube ring 16. Upper portion 16a and lower portion 16b of lube ring 16 signify the upper and lower areas of the lube ring as opposed to left and right portions (or side areas) 16c and 16d of lube ring 16 depicted in FIG. 1. There may be junctions, namely at the four “corners” of the lube ring 16, where upper and lower portions may overlap with left and right portions. Generally however, upper portion 16a signifies a lube ring area behind the blades 18, lower portion 16b signifies a lube ring area in front of the blades 18, left portion 16c signifies a lube ring area to the left of the blades 18 and right portion 16d signifies a lube ring area to the right of the blades 18, as depicted in FIG. 1. The lube ring 16 of the razor cartridge 10 shown has a frame 11 upon which the lube ring 16 is disposed. The frame 11 may desirably be a hard plastic material. In addition, it should be noted that the exterior surface 14 of left and right portions 16c and 16d of lube ring 16 (as shown in FIG. 1) may have no indicia 12 incorporated thereon, although as will be described below, alternate embodiments are contemplated in the present invention.

FIG. 1A depicts a razor or razor product 15 where cartridge 10 of FIG. 1 is operatively coupled to a top portion or cartridge connecting structure 19a of a razor handle 19. Razor 15 of the present invention is contemplated as being any type and as such, may be a male, female, disposable or permanent (e.g., system) type razor product.

The pattern 13 of indicia 12 of FIG. 1 is depicted clearly in FIG. 2 where the rest of the components including the cartridge 10 and lube ring 16 have been removed. Pattern 13 may be described as having two patterns 13a and 13b corresponding to the upper and lower portions 16a and 16b of lube ring 16, respectively. Specifically, FIG. 2 shows patterns 13a and 13b, respectively, having water droplets arranged, left to right, with one large water droplet 12a, followed by three small water droplets 12b, followed by one large water droplet 12a, followed by three small water droplets 12b and lastly followed by one large water droplet 12a.

Patterns 13a and 13b herein of indicia 12 of the present invention may be substantially identical or relatively symmetrical in both the upper and lower portions 16a and 16b of lube ring 16. Though the patterns 13a and 13b do not necessarily have to be identical or symmetrical to each other in the present invention, it may be a desirable format, as by having substantially identical or identical-looking patterns, the product may be more pleasing to the consumer or may provide more uniform functionality.

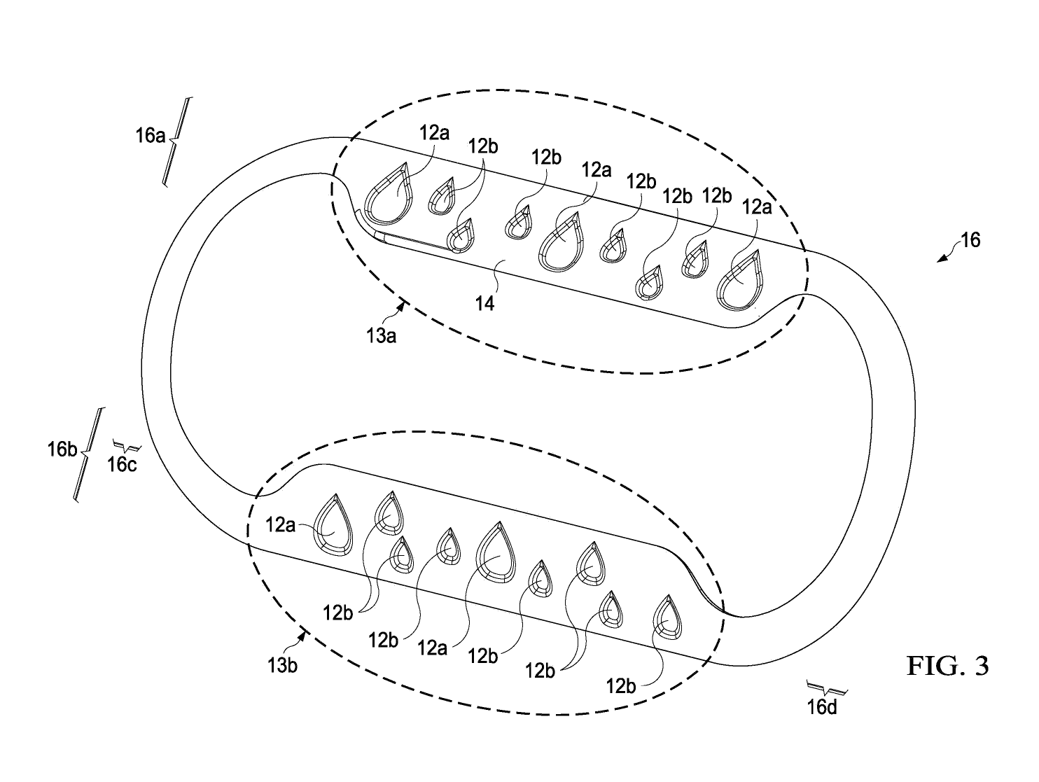

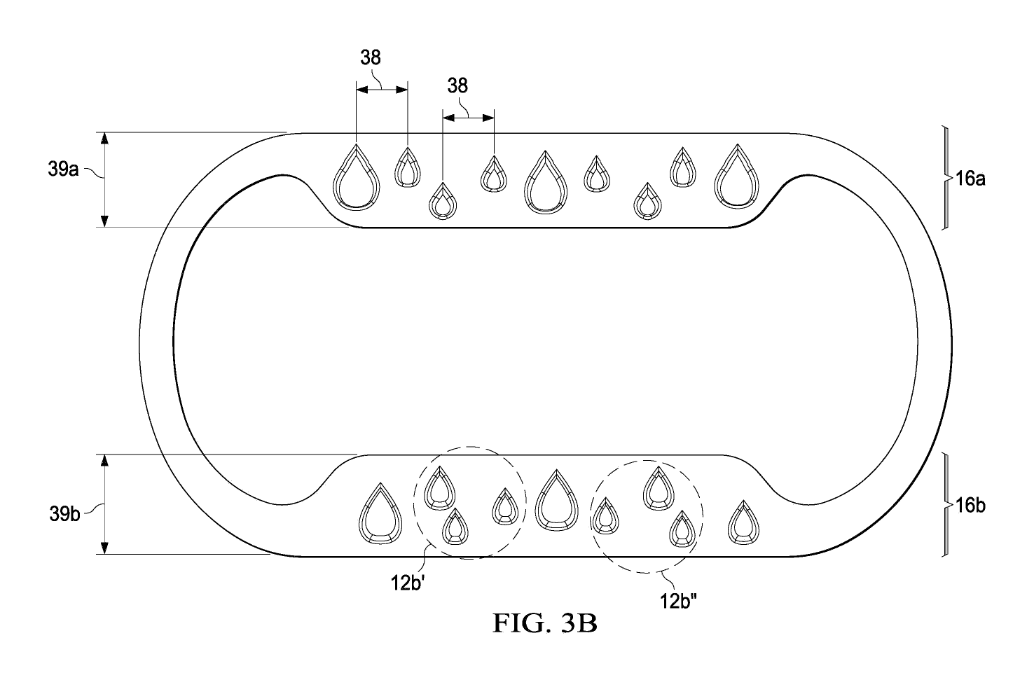

FIG. 3 depicts only the lube ring 16 of FIG. 1 (all other components of the cartridge 10 such as the blades 18 and frame 11 not shown) of the present invention with pattern 13 having patterns 13a and 13b of indicia 12 (water droplets 12a and 12b) as described above, incorporated on exterior surface 14 of upper and lower portions 16a and 16b of lube ring 16.

The indicia 12 of FIGS. 1-3 may be desirably recessed in, de-bossed or depressed onto a portion of an exterior surface 14 of lube ring 16. A process to incorporate the water droplet features of the indicia 12 into the lube ring 16 may desirably include injection molding the lube ring with a specific water droplet mold in the pattern 13 and as described above, this process may occur simultaneously with the positioning of the lube ring 16 onto the cartridge 10.

In FIGS. 1-3, the indicia 12 are each shown to be recessed entirely, in that not only a portion such as a perimeter of the water droplet is recessed.

As shown in FIG. 3A, the dimensions of a large water droplet 12a may generally range from having a length 32a of about 3.5 mm to about 4.5 mm and a width 34a from about 1.5 mm to about 2.5 mm while the dimensions of the small water droplets 12b may generally range from having a length 32b of about 2.0 mm to about 3.0 mm and a width 34b from about 0.5 mm to about 1.1 mm. Additionally, the depth 36a of each of the recesses for either a large water droplet 12a or a small water droplet 12b within the surface 14 may range anywhere from about 0.02 mm or 0.03 mm to about 0.20 to about 0.35 mm and desirably about 0.2 mm to about 0.3 mm.

It should be noted that the depth cannot be so large or deep that it impinges or breaks through the lube ring material itself or exposes the frame substrate. In some instances, a shallower recess may provide less disruption in the lube ring material structure or the lubricant flow. Typically, a lube ring material may have a thickness ranging from about 1 mm to about 2 mm. In the present invention, the thickness may or may not be uniform or the same on both the upper and lower portions 16a and 16b of lube ring 16. The lube ring thickness may generally vary from about 1.0 mm to about 1.5 mm on the lower portion 16b and may generally range from about 1.0 mm to about 2.0 mm on the upper portion 16a.

As shown in FIG. 3B of the present invention, the large and small water droplets 12a and 12b may or may not be equidistant from each other in the horizontal location. For instance, the horizontal distance 38 between any adjacent water droplet (e.g., center to center), whether taken from a large water droplet 12a adjacent to a small water droplet 12b or from a small water droplet 12b adjacent to another small water droplet 12b, may generally range from about 2.5 mm to about 4.00 mm.

The present invention contemplates the droplets may be placed in the vertical location dimension essentially anywhere in the lube taking into account for widths 39a and 39b of the lube ring at upper and lower portions 16a and 16b, respectively, said widths generally ranging from about 5.00 mm to about 9.00 mm, and desirably about 6.7 mm for the upper portion 16a and about 7.2 mm for the lower portion 16b.

Also, as shown in FIG. 3b, the vertical location of the large water droplets 12a in the upper and lower portions 16a and 16b of the lube ring 16, are generally centrally located in the upper and lower portions 16a and 16b of the lube ring 16, while the vertical location dimensions of the small water droplets 12b in the upper and lower portions 16a and 16b of the lube ring 16 may vary depending on the pattern; there may be for instance, an “up-down-up” small water droplet pattern 12a′ or 12b′ or a “down-up-down” small water droplet pattern 12b″ in patterns 13a and/or 13b.

These indicia 12 or water droplets 12a and 12b on lube ring 16 may desirably impart or provide both functional and/or aesthetic benefits to the user. With regard to functional benefits for instance, the recessed nature of the water droplets 12a and 12b may increase the surface area of the novel lube ring 16. This increased surface area may, in turn, conceivably increase the leach rate or release of lubricant of lube ring 16 during use versus lube rings of the prior art (e.g., Gillette® Venus® Embrace™). The increase in leach rate or lubricant release may conceivably range from about 5% or about 10% to about 30% or about 40% over prior art lube rings and desirably about 10% to about 40% weight loss after about a six minute soak period. It should be noted that, depending on the type, depth, and location of indicia 12 in both the upper and lower portions 16a and 16b, respectively, of lube ring 16, ostensibly different leach rates may be provided and furthermore, a different leach rate may be provided in the upper portion 16a versus that of the lower portion 16b. In addition, the leach rate may be conceivably affected were indicia to be also incorporated on left and right portions 16c and 16d.

Thus, this increase in lubricant release or improved leach rate in lube ring 16 may provide a further and significant functional benefit to the user as it may endow the user with a safer shave given that the release of more lubricant during use may decrease the amount of nicks and cuts on the user's skin while decreasing the friction or improving the glide; furthermore, the increased lubricant released may provide additional moisturization benefits to the user's skin over lube rings of the prior art both during and after the shave as a user's skin may remain moisturized for a longer period time after use.

Moreover, if the water droplets indicia 12 are visible to a user at the point of purchase as will be described in conjunction with FIG. 4, the functional benefit of the lube ring (e.g., moisturization or lubriciousness) may be communicated to the user at that point in time and with that, a functional benefit may also be communicated to the user even before use.

Not only do indicia 12 or water droplets 12a and 12b on lube ring 16 provide functional benefits to the user, they may also communicate several aesthetic benefits to the user. The water droplet pattern 13 in razor cartridge 10 of product 15 may communicate a pleasing sensation to the user before, during or after use of the razor. Indicia 12 may, for instance, provide a user the notion that the razor 15 is safe to use for sensitive skin or that the razor is otherwise appealing. During use, the indicia 12 may emit a pleasant scent or fragrance to the user providing another aesthetic benefit if the formulation includes a fragrance.

Additionally, as with functional benefits, aesthetic benefits may be conveyed or communicated to a consumer before use at the point of choosing to purchase if the indicia 12 are visible at that time. In turn, the one or more aesthetic and/or functional benefits, once communicated, may assist a consumer, in accordance with their tastes, to decide to affirmatively purchase the razor product (e.g., having a lube ring 16 with indicia 12).

If the indicia 12 are transparent or partially transparent (e.g., a cartridge showing through a package window) in a razor package, a user is provided a visual cue of the razor cartridge in its package on display in a store. This scenario, providing visibility to a consumer 43 of the indicia 12 on lube ring 16 of razor product 42 displayed on a store shelf 44 at a poignant decision moment (e.g., which product to purchase), is shown in FIG. 4 where a consumer or prospective user 43 is depicted in a store aisle 40 detecting or viewing the indicia 12 disposed on the razor product 42 but observable from the interior of the packaging 46. The indicia 12, having provided aesthetic and/or functional benefits to consumer 43, may conceivably offer the extra impetus for consumer 43 to decide to purchase product 42 rather than deciding to purchase a different product 48 (e.g., competitor's product) also displayed on (or proximal to) the shelf 44 which do not have indicia 12. Moreover, such visible incorporated indicia 12 also provide a beneficial means of debuting and conveying new features or characteristics on new razor products to the user by a razor manufacturer.

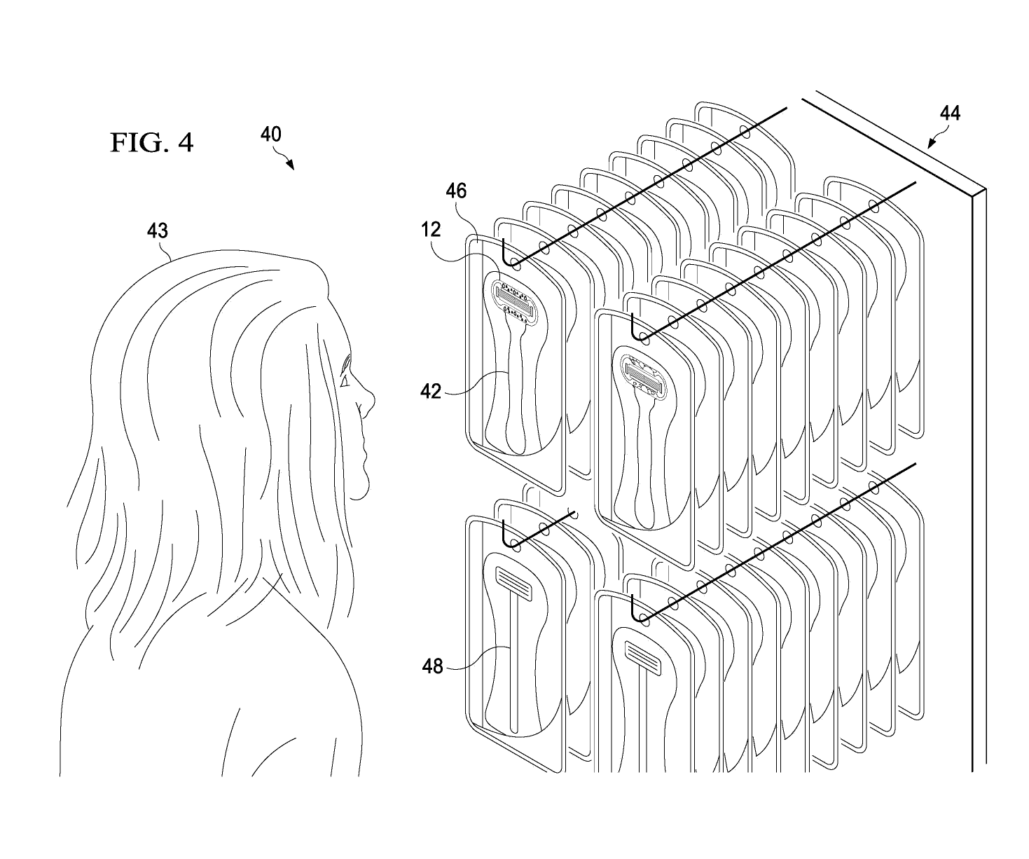

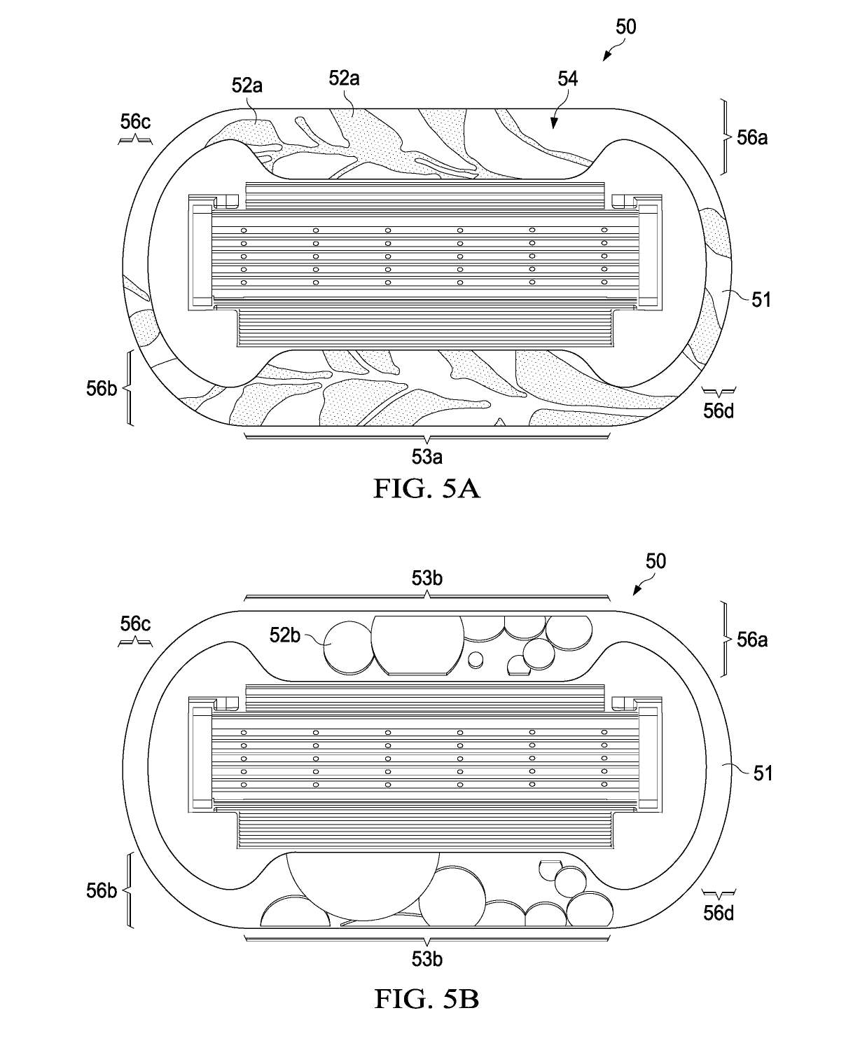

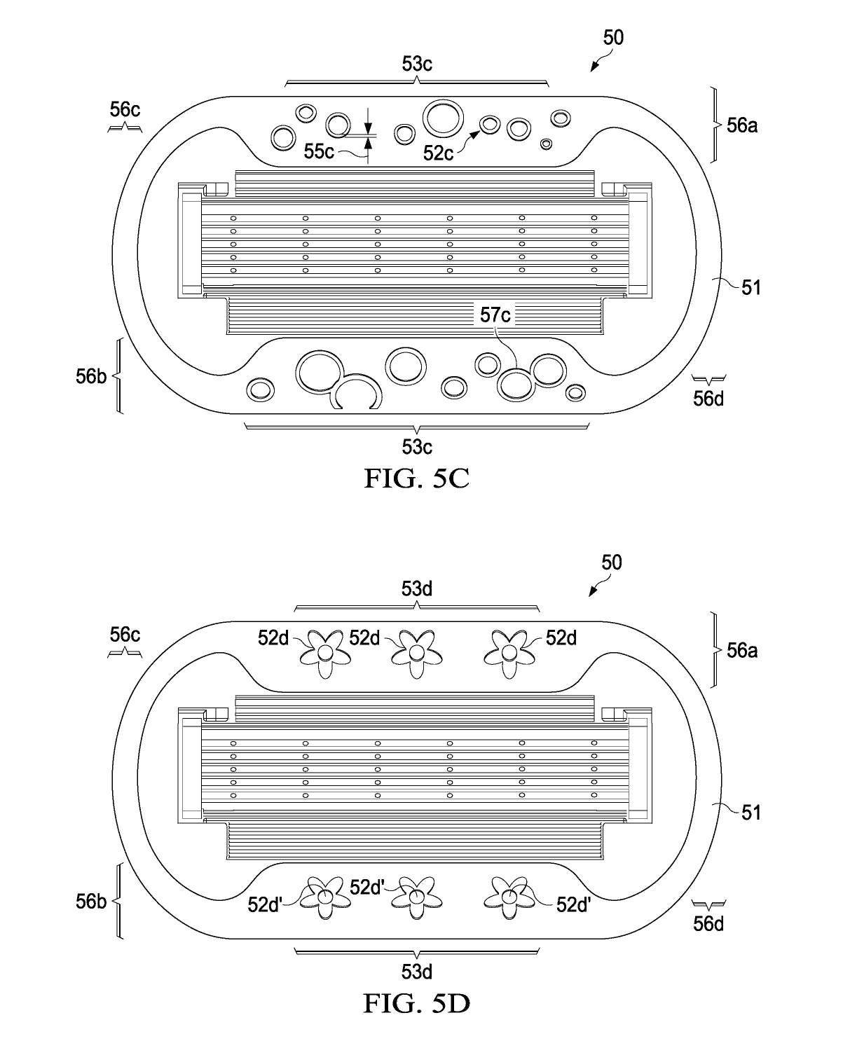

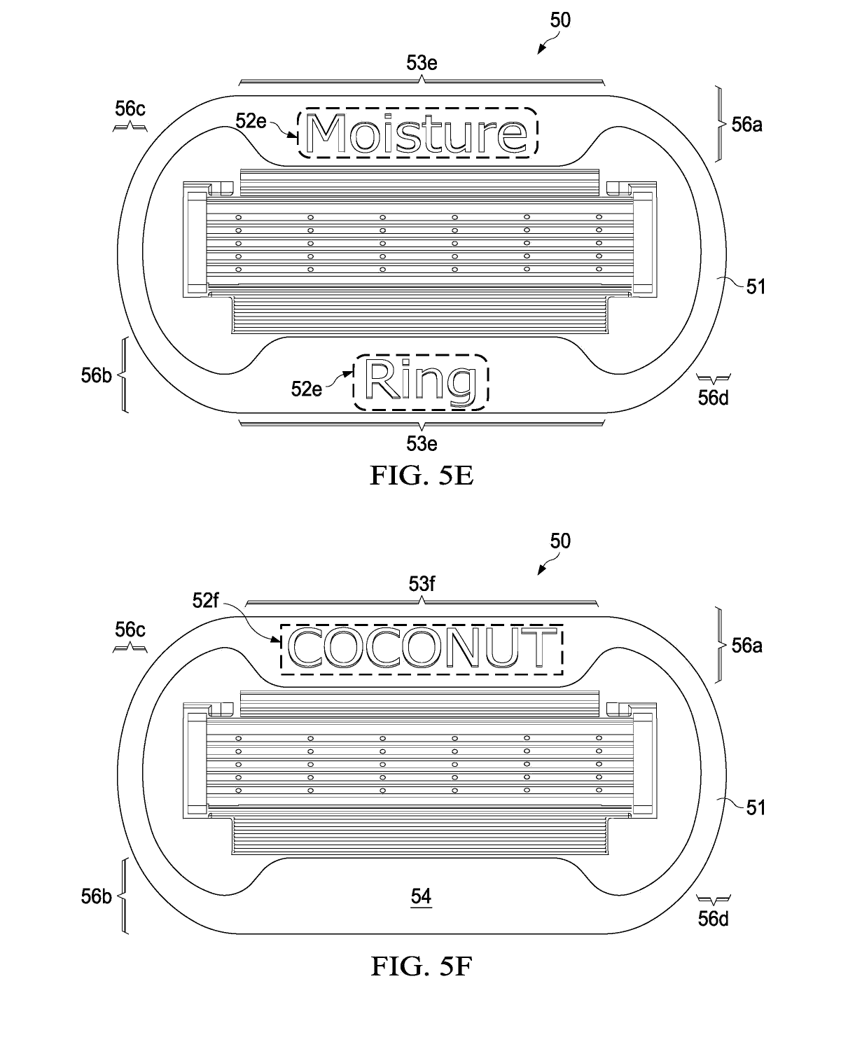

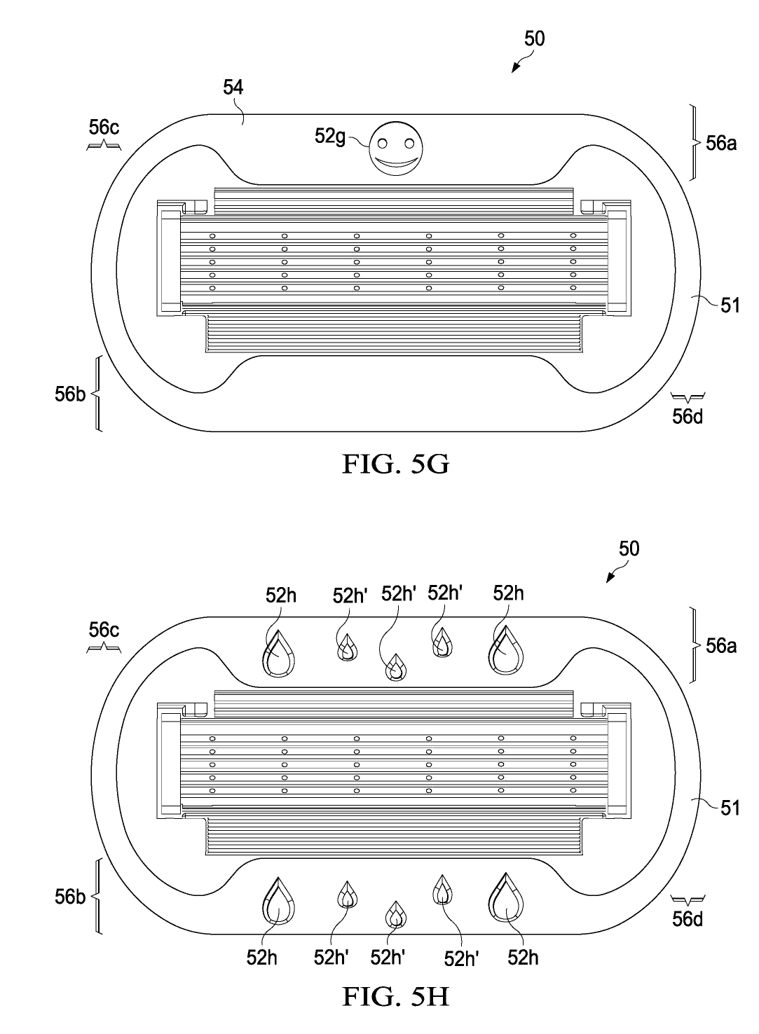

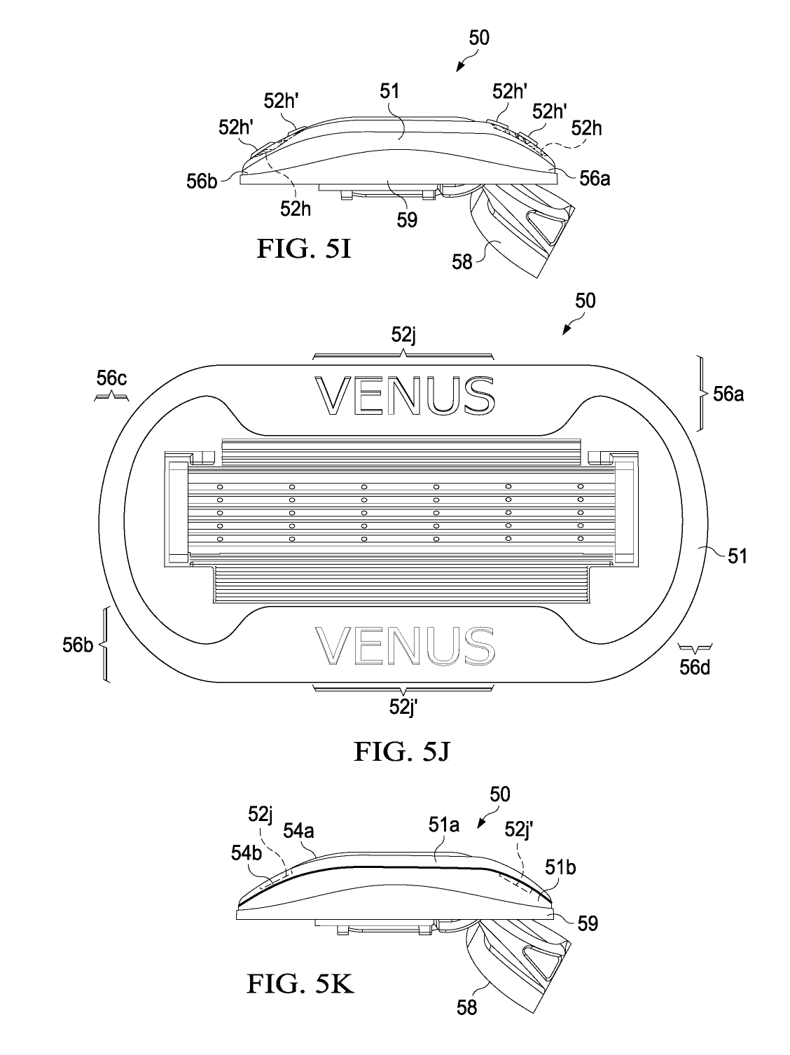

Referring now to FIGS. 5A to 5K, razor cartridges 50, each having at least one lubricating body (e.g., lube ring) with various indicia are shown in accordance with the present invention. Razor cartridges 50 coupled with any razor handle, such as depicted in FIG. 1A, form a razor which can be used to shave.

FIG. 5A depicts a novel razor cartridge 50 having a lube ring 51 with indicia 52a incorporated onto an exterior surface 54 of lube ring 51. Indicia 52a floral or vine-like features forming a design 53a disposed throughout lube ring 51. It should be noted that the design 53a of indicia 52a is incorporated onto, not just upper and lower portions 56a and 56b, respectively, of lube ring 51, but also left and right portions, 56c and 56d, respectively of lube ring 51.

The indicia 52a may be desirably incorporated onto the exterior surface 54 of lube ring 51 via printing methods such as ink-jet or laser printing using any commercially available printer. The printed areas of indicia 52a may be chosen to be one or more different colors and/or as being a different or contrasting color than lube ring 51. Indicia 52a may or may not be formed at the same time as the lube ring 51 is formed, though desirably printing of indicia 52a may occur after the lube ring is formed. Desirably the indicia 52a will be apparent to the user even after several shaves and some wearing of the lube ring 51.

Indicia 52a are not recessed as indicia 12 of FIG. 1. In addition, indicia 52a may desirably provide a slightly smoother exterior surface 54 than surface 14 of lube ring 16. Aesthetic benefits conveyed by indicia 52a to a user may include a desirable, pleasant feeling of flowers. For instance, flowers look comforting, natural, sensitive, and design 53a has appealing shapes which exude a fresh, spring-like feeling. Additionally, if a fragrance is provided within the formulation of the lube ring 51 or the indicia 52a, thereby giving off a nice scent to the user, both aesthetic and functional benefits of indicia 52a, during shaving, may be realized.

FIG. 5B of the present invention depicts razor cartridge 50 having a lube ring 51 with indicia 52b incorporated onto an exterior surface 54 of lube ring 51. Indicia 52b include a bubble pattern or design 53b disposed throughout lube ring 51. It should be noted that the pattern 53b is incorporated onto not just upper and lower portions 56a and 56b, respectively, of lube ring 51, but also left and right portions, 56c and 56d, respectively of lube ring 51.

The indicia 52b may be protruding from the surface 54, conceivably providing an increase in surface area of the lube ring over lube rings without any such indicia, and may be incorporated onto the exterior surface 54 of lube ring 51 via an injection molding process to form the bubble pattern 53b and simultaneously may place the lube ring 51 onto the frame or the cartridge, completing the formation of the cartridge 50. Each indicia 52b may desirably protrude up to about 0.02 mm to about 1.00 mm from the exterior surface 54 and each indicia 52b may have a diameter ranging in length from about 0.05 mm to about 2 mm.

Aesthetic benefits conveyed by indicia 52b to a user before or during use may include exuding an appealing, pleasant feeling of bubbles in water, a relaxing bath-time, a moisturizing, soothing experience, and/or a fresh clean feeling. Functional benefits conveyed by indicia 52b to a user during use may conceivably include an increased leach rate. Additionally, by providing moisturization to a user's skin, both aesthetic and functional benefits of indicia 52b, during and/or after shaving, are realized.

FIG. 5C of the present invention depicts razor cartridge 50 having a lube ring 51 with indicia 52c incorporated onto an exterior surface 54 of lube ring 51. Indicia 52c may form an alternate bubble pattern or design 53c disposed throughout lube ring 51. It should be noted that the pattern 53c in FIG. 5C is incorporated onto just upper and lower portions 56a and 56b, respectively, of lube ring 51, but not the left and right portions, 56c and 56d, respectively of lube ring 51.

Each indicium 52c may have protruding perimeters 57c (or partially protruding parameters) which may be incorporated onto the exterior surface 54 of lube ring 51 via an injection molding process which forms the bubble pattern 53c and simultaneously may place the lube ring 51 onto the frame or cartridge, completing the formation of the cartridge 50. Each indicia 52c may have a perimeter 57c that desirably protrudes about 0.02 mm to about 1.00 mm from the exterior surface 54 where each indicia 52c may have a diameter ranging in length from about 0.05 mm to about 2 mm. The thickness 55c of a protruding perimeter 57c may range from about 0.02 mm to about 1.00 mm.

Aesthetic benefits conveyed to a user by indicia 52c may be similar to those conveyed by indicia 52b and may include an appealing, pleasant feeling of soft bubbles in water, light and airy, bath-time, moisturizing, soothing and/or exuding a refreshing clean feeling. Additionally, by providing moisturization to a user's skin, both aesthetic and functional benefits of indicia 52c, during and/or after shaving, are realized. Theoretically the increased surface area may increase lubricant release or the leach rate.

FIG. 5D of the present invention depicts razor cartridge 50 having a lube ring 51 with indicia 52b incorporated onto an exterior surface 54 of lube ring 51. Indicia 52d may be individual flowers that form a flower pattern or design 53d disposed throughout lube ring 51. It should be noted that the pattern 53d in FIG. 5D is incorporated onto just upper and lower portions 56a and 56b, respectively, of lube ring 51, but not the left and right portions, 56c and 56d, respectively of lube ring 51.

The indicia 52d may be incorporated onto the exterior surface 54 of lube ring 51 via any method described herein (e.g., injection molded, etc.) but may desirably be incorporated by etching methods such as chemical etching, imprinted via printing methods such as ink-jet or laser printing or the use of stencil or mask. A second indicia 52d′ may also be encapsulated, layered or otherwise disposed onto exterior surface 54 of lube ring 51. For instance, indicia 52d′ may be disposed by placing one or more drops of scented oil or beads onto a center area of the indicia 52d as shown in FIG. 5D. In this way, indicia 52d′ may be incorporated within indicia 52d.

Aesthetic benefits conveyed by indicia 52d to a user may include a desirable, pleasant sentiment of flowers in that the flowers look comforting, natural, sensitive, and/or have cute, appealing shapes exuding a “fresh-like-spring-flowers” feeling. Indicia of the present invention may be geared to a particular demographic. For instance, in this embodiment, flower indicia 52d and/or the additional indicia 52d′ which includes a scent may relate well to young women, teenage or pre-teen girls. Desirably encapsulated indicia 52d′ may be activated upon use, releasing a pleasant scent. By encapsulating a pleasant scent 52d′ and/or by providing flower indicia 52d, both aesthetic and functional benefits of indicia 52d, during shaving, are realized by users. Theoretically, the increased surface area provided by indicia 52d may increase leach rate.

FIG. 5E of the present invention depicts razor cartridge 50 having a lube ring 51 with indicia 52e incorporated onto an exterior surface 54 of lube ring 51. Indicia 52e may include text or words 53e and as shown, spell the words “MOISTURE RING,” the word “MOISTURE” disposed in upper portion 56a of lube ring 51 and the word “RING” disposed in the lower portion 56b of lube ring 51. Though not precluded in the present invention, FIG. 5E does not depict words or text 53e incorporated into the left and right portions, 56c and 56d, respectively of lube ring 51.

The indicia 52e may be incorporated onto the exterior surface 54 of lube ring 51 via any method described herein but may desirably be recessed on lube ring 51 via an injection molding press process as described above. The depth of the recess (not shown) of the indicia 52e may range from about 0.02 mm to about 0.35 mm. Generally, as shown, the text is centrally positioned in both the horizontal and vertical location dimensions of the upper and lower portions 56a and 56b, respectively.

Aesthetic benefits conveyed by text indicia 52e to a user may include a pleasant reaction or opinion that the lube ring will be moisturizing, safe for sensitive skin, and soothing. Functional benefits conveyed by text indicia 52e may include knowing moisturization will be provided before use and obtaining the benefit during use and/or after use. Additionally, by providing moisturization to a user's skin, both aesthetic and functional benefits of indicia 52e, during and/or after shaving, are realized. Theoretically, the increased surface area provided by the indicia 52e may increase leach rate.

FIG. 5F of the present invention depicts razor cartridge 50 having a lube ring 51 with indicia 52f incorporated onto an exterior surface 54 of lube ring 51. The group of letters or indicia 52f form words 53f which may, for instance, desirably spell the word “COCONUT,” the word “COCONUT” shown disposed in upper portion 56a of lube ring 51. Though not precluded by the present invention, FIG. 5E does not depict text 53e incorporated into the lower portion 56b of lube ring 51 nor the left and right portions, 56c and 56d, respectively of lube ring 51.

The group of indicia 52f may be incorporated onto the exterior surface 54 of lube ring 51 via any method described herein but desirably may be protruding from lube ring 51 via injection mold pressing. The height of such protruding text of the indicia 52f may range from about 0.02 mm to about 1.00 mm. It may be desirable that the lube ring 51 be of one color (e.g., light green) and the protruding text or word 53f of indicia 52f is of a different color (e.g., off-white). In addition, the protruding text 53f of indicia 52f desirably may be generally formed of the same type of material as the lube ring 51, however it is also contemplated in the present invention to provide two different materials, one material may be provided for the lube ring 51 and a different material for the indicia 52f. For instance, the material for the indicia 52f may include different ingredients than those of the lube ring 51. For instance, ingredients that provide additional glide, essential oils or scent (e.g., coconut oil) or any other attributes that may enhance the shaving experience may be included.

With repeated use, the protruding word 53f may wear away over time, which in turn may provide a functional benefit to the user by indicating that it may be nearing the time to replace the razor cartridge 50.

Aesthetic benefits conveyed by indicia 52f to a user may include a pleasant reaction or offer the opinion that the lube ring will smell like coconut or include coconut oil, be moisturizing, be safe for sensitive skin, and/or be soothing. Additionally, by providing moisturization to a user's skin, or a scent to a user's nose, both aesthetic and functional benefits of indicia 52e, during and/or after shaving, are realized. Theoretically, the increased surface area of indicia 52f may increase leach rate.

FIG. 5G of the present invention depicts razor cartridge 50 having a lube ring 51 with indicia 52g incorporated onto an exterior surface 54 of lube ring 51 via any method described herein, but desirably may be incorporated via printing, painting or adhesive sealing. Indicia 52g may include a graphic in the form of a photo or image disposed, as shown, in upper portion 56a of lube ring 51. The face in the photo may be a happy face (as shown in FIG. 5G) or may be the face of an athlete (e.g., Tiger Woods) or other known or famous person endorsing or otherwise associated with the razor product or the manufacturer. In this way, a particular demographic may be targeted. Also, where indicia 52g are visible on the product from the package on the retail shelf (as described in conjunction with FIG. 4) a consumer may decide to purchase the product with the indicia 52g (based on observing the indicia 52g) over a competing one. Though not precluded in the present invention, FIG. 5E does not depict other indicia incorporated into lower 56b, left and/or right portions, 56c and 56d, respectively of lube ring 51.

Aesthetic benefits conveyed by indicia 52g to a user may include a pleasant reaction or offer the opinion that one will be happy using the product (e.g., happy face indicia 52g) or additionally the pure emotion that if it is good enough for the particular athlete, depicted as the indicia 52g, to use, it will certainly be good enough for the user.

FIG. 5H of the present invention depicts razor cartridge 50 having a lube ring 51 with indicia 52h and 52h′ incorporated onto an exterior surface 54 of lube ring 51 via any method described herein, but desirably may be incorporated via injection mold pressing. Indicia 52h are shown as recessed large water droplets while indicia 52h′ are shown as protruding small water droplets, thus providing a combination of types of indicia in one lube ring 51. Dimensions of the indicia 52h and 52h′ may be similar to the water droplets 12a and 12b described above in conjunction with FIG. 3A, while the recess depth of the indicia 52h may be similar to the recess depth values of water droplet 12a shown in FIG. 3A, and the protrusion height of indicia 52h′ may be similar to the height values of the bubble indicia 52b described above in conjunction with FIG. 5B. Aesthetic and functional benefits may also be similar to those described in conjunction with FIGS. 1-3 and FIG. 5B. There may conceivably be an additional functional benefit in terms of increased leach rate or lubricant release if an increase in surface area is realized with the combination of recessed and protruding indicia.

A side view of FIG. 5H is shown in FIG. 5I depicting a frame 59 and a lube ring 51 where the large water droplet indicia 52h in upper and lower portions 56a and 56b respectively are shown in dotted line format, indicating their recessed nature within the lube ring surface 54. Additionally shown are the small water droplet indicia 52h′ in upper and lower portions 56a and 56b respectively in solid line format indicating they are protruding from the lube ring surface 54. As depicted, the height of the protruding small water droplet indicia is relatively about the same as the depth of the recessed large water droplet indicia.

Referring now to FIG. 5J and FIG. 5K of the present invention, a razor cartridge 50 having a frame 59, a cartridge connecting structure 58 and a lube ring 51 with indicia 52j and indicia 52j′ incorporated onto lube ring 51 is depicted where lube ring 51 has a lower lube ring 51b and an upper lube ring 51a disposed thereon. Each lube ring 51a and 51b may have an exterior surface 54a and 54b onto which indicia 52j and 52j′ are incorporated thereon, respectively. As shown in FIG. 5J, indicia 52j on exterior surface 54a may include the word VENUS, (e.g., representing Venus®, a trade name) and may be incorporated onto the lube ring using any method described herein, but desirably may be recessed onto exterior surface 54a. Similarly, indicia 52j′ on exterior surface 54b may include any type of indicia but may desirably also include the word VENUS (e.g., again representing Venus®, a trade name) as shown in dotted line format and may be incorporated onto the lube ring 51b using any method described herein (e.g., printing, etching, etc.) but desirably may also be recessed on exterior surface 54b. Upper and lower lube rings may be formed using injection mold pressing desirably occurring in two steps, one for each ring, and may be formed of different or contrasting colors, different or similar formulations and/or different or similar characteristics, or any combination thereof. In one embodiment, upper lube ring 51a may desirably be transparent such that the indicia 52j′ on the lower lube ring 51b are visible to the user. Alternatively, the indicia 52j′ on the lower lube ring 51b may be visible to the user only after the upper lube ring 51a has worn away, typically occurring after many uses.

The present invention also contemplates that the indicia may be incorporated onto exterior surfaces of other types of lubricating bodies such as lubricating strips, soap wings (or gel bars), foams embedded with shaving aid material, or any combination thereof.

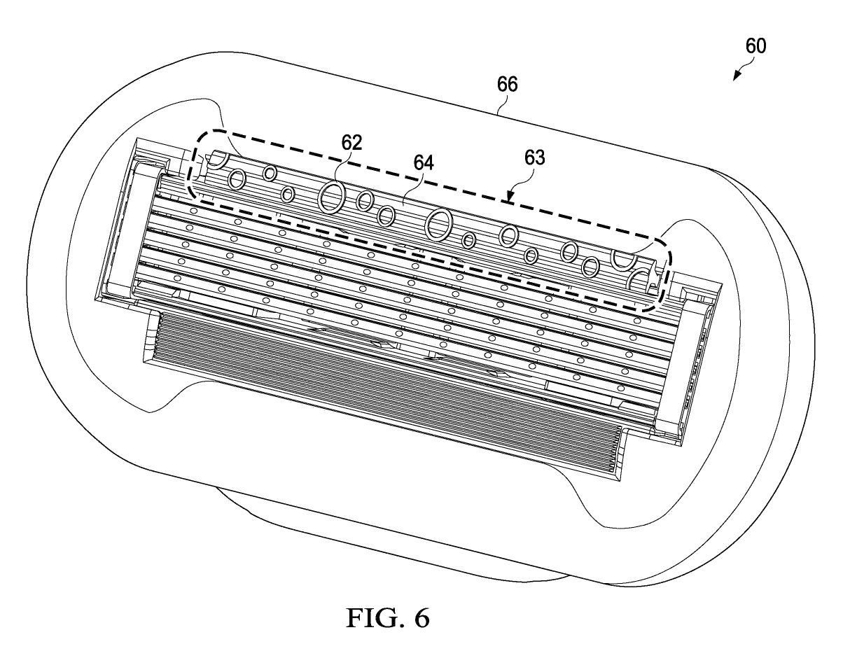

Referring now to FIG. 6 a razor cartridge 60 is shown having indicia 62 incorporated onto an exterior surface of a lubricating strip 64 (e.g., lubrastrip) in accordance with the present invention. The indicia 62 of FIG. 6 form a pattern 63 and may provide similar aesthetic and functional benefits as either of the bubble indicia 52b or 52c of FIG. 5B or FIG. 5C described above. Indicia 62 may be incorporated onto lubricating strip 64 in any manner as described above. One desirable manner for incorporating indicia 62 onto lubrastrip 64 may include inkjet or laser printing the indicia 62 forming the pattern 63 onto the exterior surface of the lubrastrip 64 in accordance with the present invention.

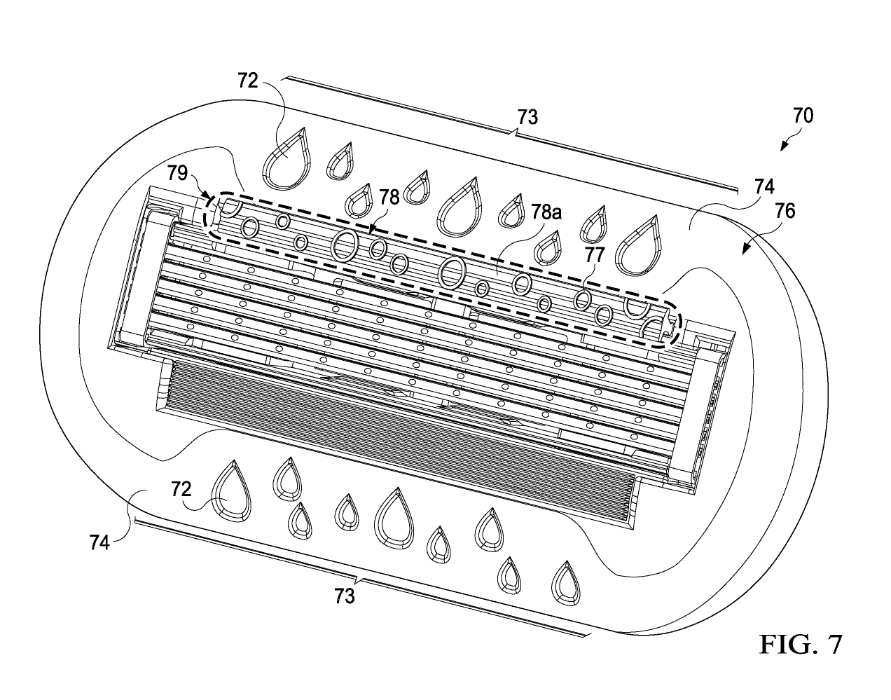

FIG. 7 depicts a razor cartridge 70 showing indicia 72 incorporated onto an exterior surface 74 of lube ring 76 and indicia 77 incorporated onto an exterior surface 78a of lubricating strip 78 in accordance with the present invention. Indicia 72 are depicted as recessed water droplets and form a pattern 73 of water droplets similar to the indicia 12 and pattern 13 described above with regard to FIG. 1. Indicia 77 are depicted as bubbles and form a bubble pattern 79 as described in similar pattern 63 of FIG. 6.

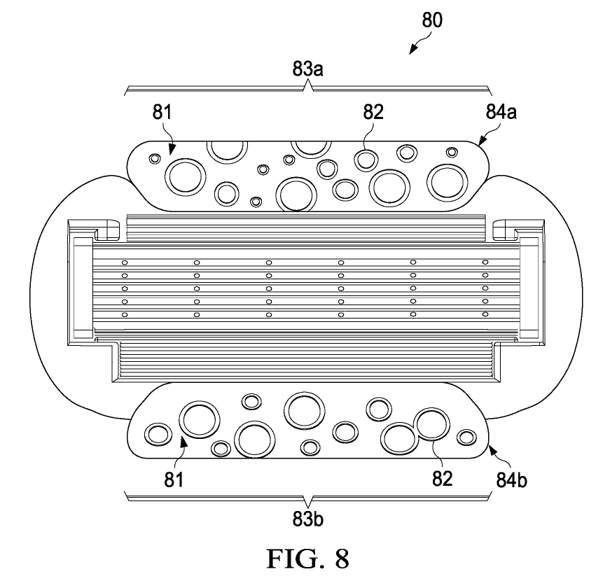

FIG. 8 depicts a razor cartridge 80 showing indicia 82 incorporated onto an exterior surface 81 of two soap wings or gel bars 84a and 84b in accordance with the present invention. Indicia 82 are depicted as bubbles and form bubble patterns 83a and 83b similar to the indicia described above with regard to FIG. 5B or FIG. 5C and may provide similar aesthetic and functional benefits as either of the bubble indicia 52b or 52c of FIG. 5B or FIG. 5C described above with differences being that pattern 83a is not identical to pattern 83b and soap wings are used instead of a lube ring. In FIG. 8, it may be desirably to provide the indicia 82 in a recessed form on the soap wings 84a and 84b. This may be accomplished via a molding of the indicia 82 onto the soap wings 84a and 84b prior to the latter's placement on the cartridge 80.

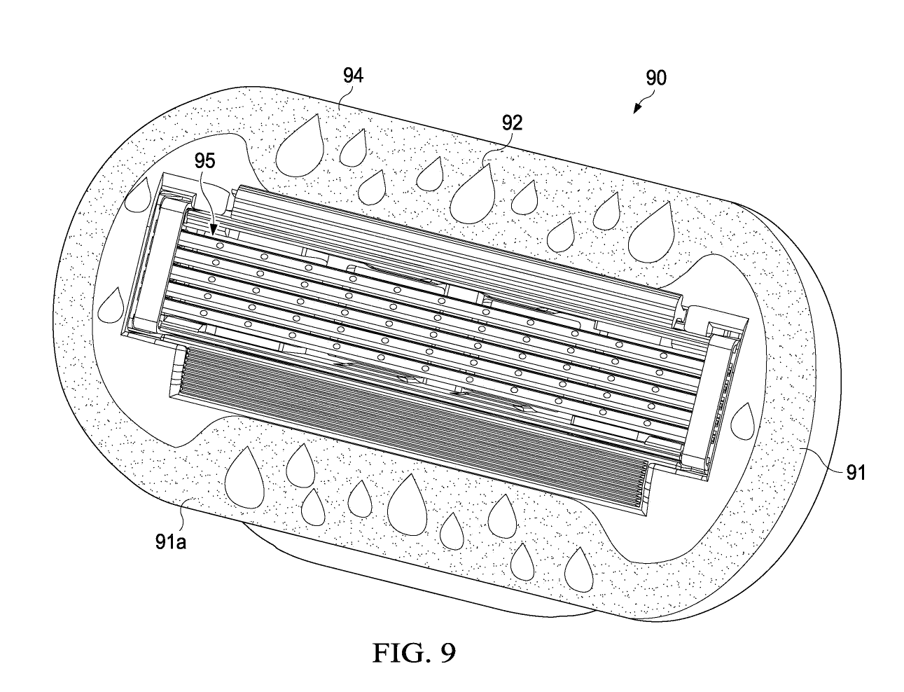

FIG. 9 depicts a razor cartridge 90 showing indicia 92 incorporated onto an exterior surface 94 of a foam 91 in accordance with the present invention. Foam 91 may be embedded with lubricating fluid (not shown) which leaches from pores 91a and foam 91 may, as shown, surround the circumference of razor blades 95 entirely. Indicia 92 are depicted as water droplets that may be desirably printed on the exterior surface 94 with inkjet or laser printing or may be incorporated via painting and/or a stencil. Indicia 92 may provide both aesthetic (e.g., pleasing) and functional benefits when these benefits are communicated to a user based on the indicia 92 being visible on the razor product in a razor package displayed on a store shelf and after repeated uses at home. Additionally, the indicia 92 may serve to provide a user with the functional benefit of providing skin moisturization or other skin improvements during and/or after use.

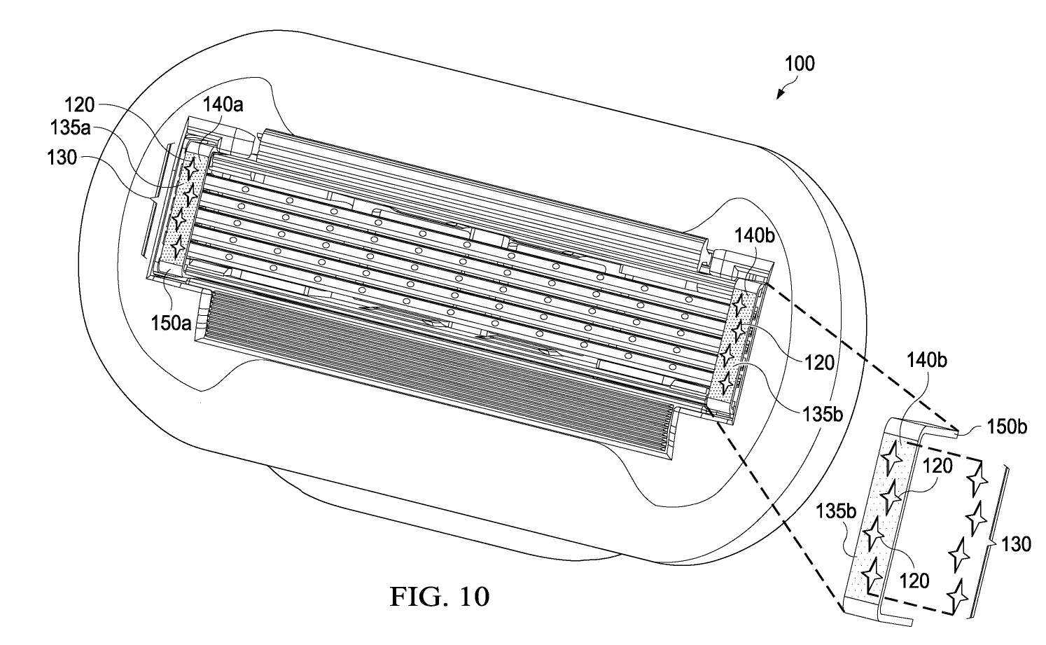

FIG. 10 depicts a razor cartridge 100 showing indicia 120 incorporated onto exterior surfaces 135a and 135b of lubrication strips or shaving aid materials 140a and 140b disposed on clips 150a and 150b in accordance with the present invention. The indicia 120 are depicted as stars or sparkles and may be incorporated via any method described herein but desirably may be printed, painted or sealed via adhesive on exterior surfaces 135a and 135b. Indicia 120 may form a pattern 130. A blow up of clip 150b, which is similar to clip 150a, is shown in FIG. 10 to clearly depict the lubricating strip 140b, its exterior surface 135b, indicia 120 and pattern 130. By being shiny, reflective and/or sparkly, indicia 120 may afford the user with aesthetic (e.g., pleasing) benefits indicating that the cartridge is clean and new. This benefit may be communicated to a user at the retail store if the indicia 120 are visible in the razor package displayed on the store shelf or during the first or subsequent uses at home.

In addition to lubricating bodies, the novel aspects of the present invention of incorporating at least one indicium onto an exterior surface of a razor cartridge component may be similarly extended to portions of at least one of the following other razor cartridge components, such as a guard, a cap, a frame, a housing, a clip, a razor blade, a cartridge connecting structure, or any combination thereof.

Referring now to FIG. 11, a razor cartridge 110 showing indicia 112 incorporated onto an exterior surface 114 of a frame 115 in accordance with the present invention while lube ring 116 may or may not have indicia disposed thereon. As shown, no indicia are incorporated onto the exterior surface 117 of lube ring 116. In this embodiment, frame 115 is shown as not including a lubricating body or shaving aid material on its surface (in contrast to FIG. 10 where the clips were coated with a shaving aid material 140a and 140b). In FIG. 11, the indicia 112 are depicted as recessed flowers and may be desirably injection molded in the frame 115 as generally described above except that in this embodiment, the indicia are molded onto the frame directly rather than onto lubricating bodies as described thus far above. Indicia 112 may include other indicia 112a (e.g., a formulation area) formed therein and thus, indicia 112 may offer the user an appealing, natural sentiment (e.g., an aesthetic benefit) and may conceivably, if incorporated with a fragrant formulation, emit a pleasing scent with moisturization thus providing still other functional or aesthetic benefits. The depth and dimensions of the recessed flowers may desirably similar to the ranges described above in conjunction with the water droplets shown in FIG. 3A.

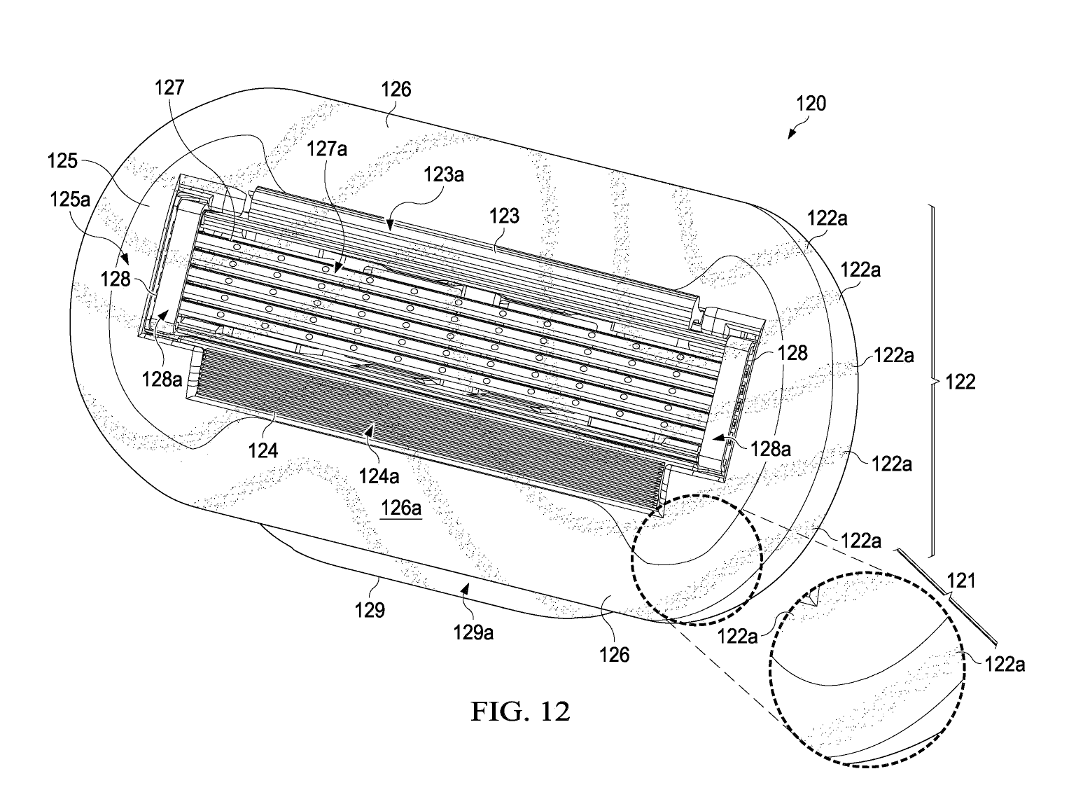

In FIG. 12, a razor cartridge 120 is shown to include indicia 122 incorporated onto exterior surfaces of all components of the razor cartridge 120. Indicia 122 are depicted as a wavy pattern 121 of lines 122a that may be spray painted, brushed or inkjet printed (the latter depicted), onto an entire exterior surface of the razor cartridge covering, as shown, portions of each of the following: the exterior surface 123a of the lubricating strip 123, the exterior surface 124a of the guard 124, the exterior surface 125a of the frame 125, the exterior surface 126a of the lube ring 126, the exterior surface 127a of the blades 127, exterior surfaces 128a on the clips 128 on either side of the blades 127, and the exterior surface 129a of the cartridge connecting structure 129. Though the housing also has an exterior surface and is also contemplated as a razor cartridge component in the present invention, it is generally a small area and not described in this embodiment. The pattern 121 of lines 122a of indicia 122 connote a light, airy, vacation or being at the seashore type feeling (e.g., an aesthetic benefit) to the user.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A razor cartridge comprising at least one indicium incorporated onto at least one exterior surface of at least one component of said razor cartridge.

2. The cartridge of claim 1 wherein said at least one indicium provides a user with at least one functional benefit, at least one aesthetic benefit, or any combination thereof.

3. The cartridge of claim 1 wherein said at least one indicium comprises one or more pattern, graphic, text, design, fragrance, or any combination thereof.

4. The cartridge of claim 1 wherein said at least one indicium comprises one or more water droplets, flowers, floral patterns, bubbles, sparkles, words, images, scents, or any combination thereof.

5. The cartridge of claim 2 wherein said at least one functional benefit comprises increased lubricant release, release of a scent during use, skin or hair improvements further comprising moisturization, hair minimization or acne-reduction, or any combination thereof.

6. The cartridge of claim 2 wherein said at least one aesthetic benefit comprises at least one pleasing sensation, at least one pleasing emotion obtained via a scent released during use, improved skin appearance, or a feeling that said razor cartridge is appealing, refreshing, clean, easy to use, moisturizing, relaxing, soothing, or safe for sensitive skin, or any combination thereof.

7. The cartridge of claim 2 wherein each of said benefits is obtained by said user before, during or after use of said cartridge, or any combination thereof.

8. The cartridge of claim 1 wherein said at least one component comprises a portion of at least one of the following: a lubricating body, a cap, a housing, a frame, a clip, a guard, a razor blade, a cartridge connecting structure, or any combination thereof.

9. The cartridge of claim 8 wherein said lubricating body is at least one of the following: a lubricating ring, a lubricating strip, a soap, a gel bar, a foam embedded with a lubricious material, a shaving aid material disposed on said at least one razor cartridge component, or any combination thereof.

10. The cartridge of claim 1 wherein said at least one indicium is recessed in, protruding from, etched into, printed on, encapsulated in, painted on, sealed on, stenciled on, within another indicia, layered onto another indicia, or any combination thereof, said at least one exterior surface of said at least one razor cartridge component.

11. The cartridge of claim 10 wherein a width of said at least one indicium ranges from about 0.5 mm to about 2.5 mm and a length of said at least one indicium ranges from about 2.0 mm to about 4.5 mm.

12. The cartridge of claim 10 wherein a depth of said recessed indicia ranges from about 0.02 mm to about 0.35 mm into said exterior surface and a height of said protruding indicia ranges from about 0.02 mm to about 1.00 mm above said exterior surface.

13. The cartridge of claim 9 wherein said lubricating ring has an upper portion, a lower portion, a left portion, a right portion, an upper layer or a lower layer or any combination thereof.

14. The cartridge of claim 13 wherein said at least one indicium further comprise water droplets recessed in said upper and lower portions of said lube ring.

15. The cartridge of claim 1 wherein said at least one indicium is visible to a consumer at a point of purchase of a razor product.

16. The cartridge of claim 15 wherein said at least one indicium's visibility allows said consumer to select said razor product according to their tastes.

17. A razor comprising at least one indicium incorporated into at least one component of a razor cartridge wherein said at least one indicium is visible to a user at a point of purchase of said razor.

18. The razor of claim 17 wherein said at least one visible indicium provides said user with at least one functional benefit, at least one aesthetic benefit, or any combination thereof wherein each said benefit is obtained by said user before, during or after use of said cartridge, or any combination thereof.

19. The razor of claim 17 wherein said at least one razor cartridge component comprises a portion of at least one of the following: a lubricating body, a guard, a cap, a housing, a frame, a clip, a razor blade, a cartridge connecting structure, or any combination thereof.

20. A method of making a razor cartridge comprising incorporating at least one indicium on at least one exterior surface of at least one component of said razor cartridge wherein said at least one razor cartridge component comprises a portion of at least one of the following: a lubricating body, a guard, a cap, a housing, a frame, a clip, a razor blade, a cartridge connecting structure, or any combination thereof.

21. The method of claim 20 wherein said lubricating body is at least one of the following: a lubricating ring, a lubricating strip, a soap, a gel bar, a foam embedded with a lubricious material, a shaving aid material disposed on said at least one razor cartridge component, or any combination thereof.

22. The method of claim 20 wherein said at least one indicium provides a user with at least one functional benefit, at least one aesthetic benefit, or any combination thereof.

23. The method of claim 20 wherein said at least one indicium comprises one or more pattern, graphic, text, design, scent or any combination thereof.

24. The method of claim 20 wherein said incorporating said at least one indicium further comprises being recessed in, protruding from, etched into, printed on, encapsulated in, painted on, sealed on, stenciled on, formed within another indicia, layered on another indicia, or any combination thereof, said at least one exterior surface of said razor cartridge component.

25. The method of claim 20 wherein said at least one recessed indicium and said at least one protruding indicium are formed via injection molding and said at least one printed indicium is formed via a laser printer, an ink-jet printer or any combination thereof.
